(19) United States
(12) Patent Application Publication
(10) Pub. No.: US 2025/0331588 A1
(43) Pub. Date: Oct. 30, 2025

(54) ELECTRIC PLIER FOR HAIR EXTENSIONS

(71) Applicant: Holly Lynn Wyrembelski, Mount Pleasant, MI (US)

(72) Inventors: Holly Lynn Wyrembelski, Mount Pleasant, MI (US); Noah McNeely, Grayson, GA (US)

(21) Appl. No.: 19/189,839

(22) Filed: Apr. 25, 2025

Related U.S. Application Data
(60) Provisional application No. 63/638,752, filed on Apr. 25, 2024.

(51) Int. Cl. A41G 5/00; B25B 7/04; B25B 25/00

(52) U.S. Cl. CPC A41G 5/0086; B25B 7/04; B25B 25/00

(57) ABSTRACT

An electric crimping tool includes a body and an electric motor. The body includes a charging port and an actuator. A crimping head is mounted to the body. The crimping head includes a mounting body and a pair of crimping jaws carried by the mounting body. An operating mechanism is operably coupled with the actuator and the electric motor to actuate automatic opening and closing of the pair of crimping jaws.

### CROSS-REFERENCE TO RELATED APPLICATIONS

This application claims the benefit of U.S. Provisional Application No. 63/638,752 filed Apr. 25, 2024, the entire disclosure of which is incorporated by reference.

### FIELD

The present disclosure relates to the field of hair accessories and more particularly to an electric crimping tool for use with hair extensions.

### BACKGROUND

Hair extensions are a popular beauty accessory that individuals use to add length, volume, and texture to their natural hair. These extensions are typically made from a variety of materials, with human hair and synthetic fibers being the most common. Human hair extensions are sourced from donors and undergo a careful process to maintain their natural texture and appearance. They offer a seamless blend with one's own hair, providing a more realistic and natural look. On the other hand, synthetic hair extensions are created using man-made fibers designed to mimic the texture and appearance of human hair.

Hair extension pliers or crimping tools play a crucial role in both the installation and removal of different types of extensions, offering precision and efficiency in the process. In the case of tape-in extensions, these pliers or crimping tools are instrumental in the removal process. The extensions are attached using double-sided tape, and the pliers are used to gently break the bond between the tape and the natural hair. By applying pressure with the pliers and carefully peeling the tape away, stylists can ensure a smooth and residue-free removal. This method is not only efficient but also minimizes the risk of damage to the natural hair.

For fusion extensions, which involve attaching individual strands of hair using keratin bonds, hair extension pliers are used to facilitate their removal. These pliers have a flat, heated clamp that softens the keratin bond. The stylist carefully squeezes the bond with the pliers, melting the adhesive and allowing for an easy release of the extension. This technique ensures a gentle removal process without causing unnecessary stress or damage to the natural hair.

However, hair stylists who use extension pliers on a daily basis may face health issues due to the repetitive motion and pressure of constantly opening and closing the pliers. This repetitive strain can lead to conditions such as arthritis and tennis elbow, causing pain, inflammation, and reduced mobility in the affected joints. The impact of these health issues extends beyond the immediate discomfort, affecting the stylist's ability to perform their job effectively. Chronic pain and reduced joint mobility can lead to a decline in the quality and speed of work, impacting both the stylist's career and overall well-being.

Recognizing the potential health issues associated with the repetitive use of hair extension pliers, the beauty industry has started exploring and implementing solutions to alleviate the strain on stylists. One approach involves the development of hand tools with ergonomic designs, featuring handles with a more comfortable grip to reduce stress on the hands and wrists. These tools may incorporate cushioning or non-slip materials to enhance the stylist's comfort during prolonged use.

However, while these current solutions represent positive steps toward mitigating the strain on stylists, there remains a significant challenge in addressing the pain caused by constant and recurring pressure from manual pliers. Particularly, despite ergonomic improvements, the fundamental issue of repetitive motion leading to conditions like arthritis and tennis elbow persists. Stylists often engage in long hours of intricate work, requiring them to repeatedly open and close the pliers, creating ongoing stress on their hands and wrists. As of now, no solution completely eliminates the discomfort arising from the continuous use of manual pliers in hair extension applications. Accordingly, a suitable solution is desired.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

One aspect of the disclosure provides an electric crimping tool including a body. The body includes a charging port and an actuator. The electric crimping tool also includes an electric motor and a crimping head mounted to the body. The crimping head includes a mounting body. A pair of crimping jaws is carried by the mounting body. An operating mechanism is operably coupled with the actuator and the electric motor to actuate automatic opening and closing of the pair of crimping jaws.

Another aspect of the disclosure provides an electric plier. The electric plier includes a charging dock portion having a charging port and a power button. An electric plier head portion is attached to the charging dock portion. The electric plier head portion includes a pair of hinged jaw halves. The electric plier further includes an automatic means of opening and closing the pair of hinged jaw halves.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a side perspective view of an electric plier for hair extensions including a charging dock portion and an electric plier head portion, according to one or more principles of the present disclosure.

FIG. 2 is a side perspective view of the electric plier for hair extensions including the charging dock portion and another electric plier head portion, according to one or more principles of the present disclosure.

FIG. 3 is a side perspective view of the electric plier for hair extensions including the charging dock portion and still another electric plier head portion, according to one or more principles of the present disclosure.

FIG. 4 is a front view of the electric plier for hair extensions including a power button and a plurality of comfort grips, according to one or more principles of the present disclosure.

FIG. 5 is a bottom perspective view of the electric plier for hair extensions, according to one or more principles of the present disclosure.

FIG. 6 is a side perspective view of an electric plier head portion, according to one or more principles of the present disclosure.

FIG. 7 is a side perspective view of another electric plier head portion, according to one or more principles of the present disclosure.

FIG. 8 is a side perspective view of another electric plier head portion, according to one or more principles of the present disclosure.

FIG. 9 is a side perspective view of an electric crimping tool according to the principles of the present disclosure.

FIG. 10 is a side view of the electric crimping tool of FIG. 9 according to the principles of the present disclosure.

FIG. 11 is a side perspective view of a cross-section of the electric crimping tool of FIG. 9, including an example of an actuating mechanism for operating the electric crimping tool according to the principles of the present disclosure.

FIG. 12 is an enlarged side perspective view of a portion of the cross-section of FIG. 11 according to the principles of the present disclosure.

FIG. 13 is a partially exploded perspective view of the electric crimping tool of FIG. 9 according to the principles of the present disclosure.

FIG. 14 is a is a side view of a cross-section of the electric crimping tool of FIG. 9, including another example of an actuating mechanism for operating the electric crimping tool according to the principles of the present disclosure.

In the drawings, reference numbers may be reused to identify similar and/or identical elements.

### DETAILED DESCRIPTION

### Introduction

The present disclosure is directed to an electric plier or electric crimping tool for hair extensions. The electric plier for hair extensions advantageously addresses the aforementioned deficiencies by providing an automatic means of opening and closing pliers used for hair extensions. Thus, the aforementioned problems associated with manually opening and closing pliers when removing and installing hair extensions are avoided.

In a first aspect of the disclosure, an electric plier for hair extensions comprises at least one electric plier head portion and a charging dock portion. In a second aspect, the charging dock portion may include a body having a charging dock top end and a charging dock bottom end opposite the charging dock top end. In some aspects, the charging dock portion may include a tubular or cylindrical configuration. Particularly, the charging dock bottom end may include a circular cross-section being substantially flat, enabling the charging dock portion to be stood on a surface. The body may include a tapered cylindrical top, narrowing toward the charging dock top end. It should however be appreciated that the charging dock portion is not limited to this particular configuration.

In another aspect, the at least one electric plier head portion may be configured to attach to the charging dock top end of the charging dock portion. As such, at the charging dock top end may be a charging dock portion fastener assembly 110. The charging dock portion may include a shaft extending upwardly from the charging dock top end of the charging dock portion. The charging dock portion fastener assembly 110 may be attached atop the charging dock top end.

The charging dock portion fastener assembly 110 may include a bracket having a generally U-shape configuration. The bracket may include a horizontal member having a first horizontal member end, and a second horizontal member end opposite the first horizontal member end. A first upwardly extending member may be attached to the first horizontal member end and a second upwardly extending member may be attached to the second horizontal member end. Each of the first and second upwardly extending member ends may include one of a pair of first apertures.

The at least one electric plier head portion may include a corresponding plier head fastener portion configured to interface with the charging dock portion fastener assembly 110 of the charging dock portion. For example, the at least one electric plier head portion may include a pair of second apertures each attached to a side of the at least one electric plier head portion. As such, the pair of first apertures may be aligned with the pair of second apertures; and fastening members, such as bolts, may be inserted through the aligned pair of first and second apertures to attach the at least one electric plier head portion to the charging dock portion. This means of fastening may enable movement of the at least one electric plier head portion between a vertical position and a horizontal position; further, the fastener may enable extension of the at least one electric plier head portion. This may enable a user to move the at least one electric plier head portion into a more ergonomically correct position.

In another aspect, the at least one electric plier head portion may include a pair of jaw halves hinged together at a first jaw half end of the at least one electric plier head portion. Opposite the first jaw half end of the at least one electric plier head portion may be a second jaw half end of the at least one electric plier head portion. Each of the pair of jaw halves may include an exterior surface and an interior surface opposite the exterior surface. In some aspects, at least a portion of the interior surface may include a tool element for achieving a particular purpose in the hair.

In another aspect, the pair of jaw halves may be able to pivot at the first jaw half end to selectively close the pair of jaw halves, bringing the pair of jaw halves together, wherein the interior surface of the pair of jaw halves are placed in contact with each other. In another aspect, the at least one electric plier head portion may include a plurality of electric plier head portions. In some embodiments, each of the plurality of electric plier head portions may include a different type of tool element, allowing a user to interchange the plurality of electric plier head portions depending on what purpose is needed for the hair extensions.

In another aspect, the charging dock portion may include a rechargeable battery disposed therewithin; at a side of the charging dock portion may include a charging port in communication with the rechargeable battery and configured to accept a charging cable to provide power to the rechargeable battery, thereby enabling recharging of the rechargeable battery. For example, the charging port may be located on the charging dock portion bottom end of the charging dock portion.

In another aspect, a power button may further be located on the body of the charging dock portion, the power button may be in communication with the pair of jaw halves such that actuation of the power button closes the pair of jaw halves. In another aspect, one or more settings buttons may further be located on the body of the charging dock portion. The one or more settings buttons may enable selection of one or more settings to control degree of closure of the pair of jaw halves. For example, one setting may cause the pair of jaw halves to completely close upon pressing the power button; and another setting may cause the pair of jaw halves to close partially upon pressing the power button.

In another aspect, in some examples, comfort grips may also be provided on the body of the charging dock portion, for example, the comfort grips may include grooves for accepting fingers of a user.

In use, a user may select an appropriate electric plier head portion based on the desired result for the hair extension. The user may then attach the selected electric plier head portion to the charging dock portion via the plier head fastener portion and the corresponding fastener on the pair of jaw halves.

These and other objects, features, and advantages of the present disclosure will become more readily apparent from the attached drawings and the detailed description of the aspects of the present disclosure, which follow.

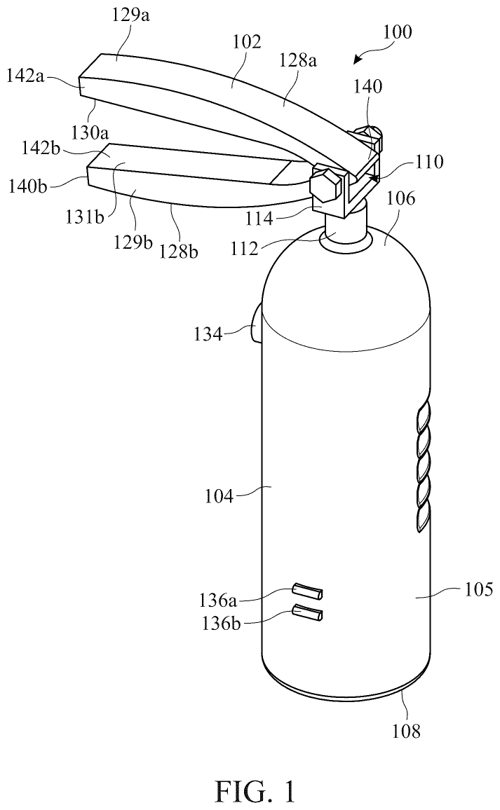

### The Examples of FIGS. 1-8

The following detailed description is merely exemplary in nature and is not intended to limit the described aspects or the application and uses of the described aspects. As used herein, the word “exemplary” or “illustrative” means “serving as an example, instance, or illustration.” Any aspect or principle described herein as “exemplary” or “illustrative” is not necessarily to be construed as preferred or advantageous over other aspects. All of the aspects described below are exemplary aspects provided to enable persons skilled in the art to make or use the aspects of the disclosure and are not intended to limit the scope of the disclosure, which is defined by the claims.

For purposes of description herein, the terms “upper”, “lower”, “left”, “rear”, “right”, “front”, “vertical”, “horizontal”, and derivatives thereof shall relate to the disclosure as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary aspects of the concepts of the present disclosure defined in the appended claims. Hence, specific dimensions and other physical characteristics relating to the aspects disclosed herein are not to be considered as limiting, unless the claims expressly state otherwise.

It should be appreciated that the term “comprising” can also encompass the terms “consisting essentially of” and “consisting of”.

Shown throughout the figures, the present disclosure is directed toward an electric plier for hair extensions. The electric plier for hair extensions is used to provide an automatic means of opening and closing pliers, for particular use with hair extensions. As such, a user does not need to consistently manually open and close pliers, thereby preventing any pain associated therewith.

Referring initially to FIGS. 1-3, there are shown various side perspective views of an electric plier for hair extensions 100, according to one or more aspects of the present disclosure. As shown, here the electric plier for hair extensions 100 may include at least one electric plier head portion 102 and a charging dock portion 104.

Particularly, as shown here, the at least one electric plier head portion 102 may include a plurality of electric plier head portions 102, condensing many tools into one. In some embodiments, each of the plurality of electric plier head portions 102 may include a different type of tool element 131 a, 131 b, allowing a user to interchange the plurality of electric plier head portions 102 depending on what purpose is needed for the hair extensions. As such, the electric plier head portion 102 may be interchangeable.

For example, one electric plier head portion 102 may be utilized for sealing tape-in hair extensions with little effort or strain to the user's hand, wrist, elbow, etc. In another example, another electric plier head portion 102 may allow the user to break bonds on fusion extensions for easy release.

As shown in these figures, the charging dock portion 104 may include a body 105 having a charging dock top end 106 and a charging dock bottom end 108 opposite the charging dock top end 106. In some embodiments, the charging dock portion 104 may include a tubular or cylindrical configuration. Particularly, the charging dock bottom end 108 may include a circular cross-section being substantially flat, enabling the charging dock portion 104 to be stood on a surface. The body 105 may include a tapered cylindrical top, narrowing toward the charging dock top end 106. It should however be appreciated that the charging dock portion 104 is not limited to this particular configuration.

As shown in these figures, the at least one electric plier head portion 102 may be configured to attach to the charging dock top end 106 of the charging dock portion 104. As such, at the charging dock top end 106 may be a charging dock portion fastener assembly 110. In some aspects, the charging dock portion 104 may include a shaft 112 extending upwardly from the charging dock top end 106 of the charging dock portion 104.

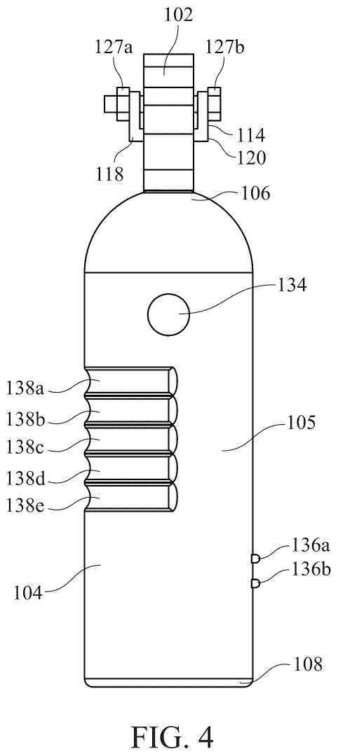

The charging dock portion fastener assembly 110 may be attached atop the charging dock top end 106. The charging dock portion fastener assembly 110 may include a bracket 114 having a generally U-shape configuration. Particularly, in some aspects, the bracket 114 may include a horizontal member 116 having a first horizontal member end 118 (FIG. 4), and a second horizontal member end 120 (FIG. 4) opposite the first horizontal member end 118.

A first upwardly extending member 122 may be attached to the first horizontal member end 118 and a second upwardly extending member 123 may be attached to the second horizontal member end 120. Each of the first and second upwardly extending member 122, 123 ends may include one of a pair of first apertures (not illustrated).

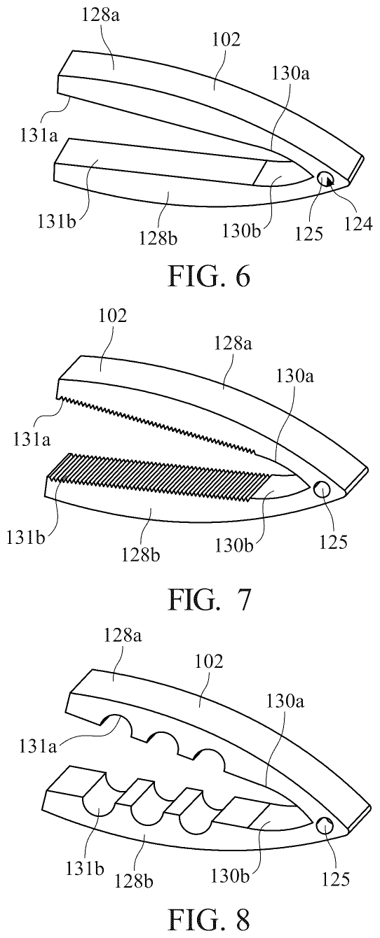

Accordingly, each of the plurality of electric plier head portions 102 may include a corresponding plier head fastener portion 124 configured to interface with the charging dock portion fastener assembly 110 of the charging dock portion 104. For example, in some embodiments, each of the plurality of electric plier head portions 102 may include a pair of second apertures 125 each attached to a side of each of the plurality of electric plier head portions 102, as shown in FIGS. 6-8.

As such, in use in attaching each of the plurality of electric plier head portions 102 to the charging dock portion 104, the pair of first apertures may be aligned with the pair of second apertures 125; and fastening members, such as bolts 127 a, 127 b, may be inserted through the aligned pair of first apertures and the pair of second apertures 125 to attach the electric plier head portions 102 to the charging dock portion 104 (one in use at a time).

This means of fastening may enable easy installation and removal of each of the plurality of electric plier head portions 102, enabling quick and efficient interchangeability of the plurality of electric plier head portions 102.

Further, this means of fastening may enable movement of each of the plurality of electric plier head portions 102 between a vertical position and a horizontal position. For example, in the horizontal position, a longitudinal axis of each of the plurality of electric plier head portions 102 may be generally perpendicular to a longitudinal axis of the charging dock portion 104; and in the vertical position, the longitudinal axis of each of the plurality of electric plier head portions 102 may be generally aligned or parallel to the longitudinal axis of the charging dock portion 104.

Further, this means of fastening may enable extension of each of the plurality of electric plier head portions 102. The ability to move each of the plurality of electric plier head portions 102 may enable a user to move each of the plurality of electric plier head portions 102 into a more ergonomically correct position, again contributing to the comfortability of the electric plier for hair extensions 100 as opposed to traditional manual pliers used for hair extensions.

As shown in FIGS. 1-3, each of the plurality of electric plier head portions 102 may include a pair of jaw halves 128 a, 128 b hinged together at a first jaw half end 140 of the electric plier head portion 102. As shown here, the first jaw half end 140 of the pair of jaw halves 128 a, 128 b may attach to the charging dock portion fastener assembly 110 of the charging dock portion 104. As shown here, opposite the first jaw half end 140 of each of the plurality of electric plier head portions 102 may be a second jaw half end 142 a, 142 b. The pair of jaw halves 128 a, 128 b may be able to pivot at the first jaw half end 140 relative each other to selectively close the pair of jaw halves 128 a, 128 b and bring the pair of jaw halves 128 a, 128 b together.

Further, each of the plurality of electric plier head portions 102 may include an exterior surface 129 a, 129 b and an interior surface 130 a, 130 b opposite the exterior surface 129 a, 129 b. In some aspects, as discussed above, at least a portion of the interior surface 130 a, 130 b may include a tool element 131 a, 131 b for achieving a particular purpose on the hair extensions. When the pair of jaw halves 128 a, 128 b are pivoted into a closed position, this may bring the interior surface 130 a, 130 b of the pair of jaw halves 128 a, 128 b in contact with each other, sandwiching the hair extension therebetween to perform work on the hair extension.

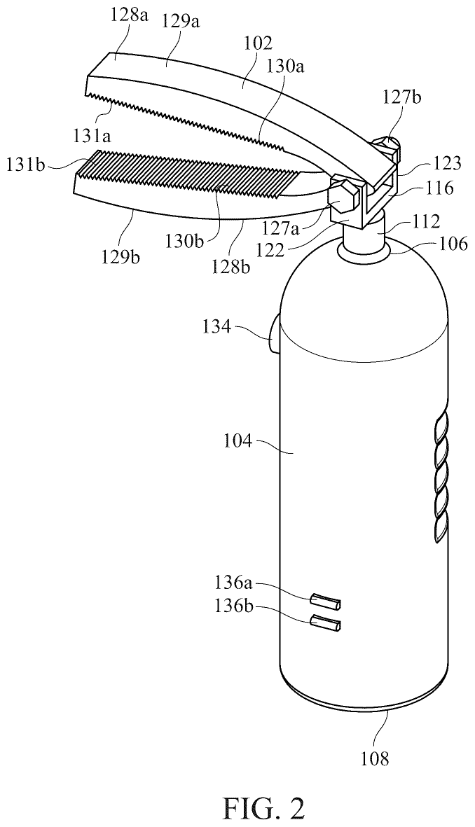

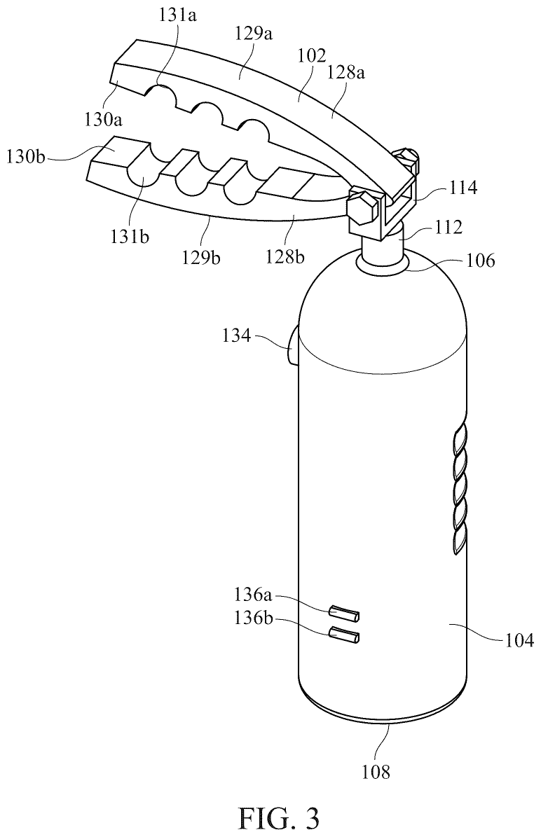

FIGS. 1-3 demonstrate three different electric plier head portions 102. For example, the tool element 131 a, 131 b shown on the interior surface 130 a, 130 b of each jaw half 128 a, 128 b of the electric plier head portion 102 shown in FIG. 1 includes a smooth flat surface; the tool element 131 a, 131 b shown on the interior surface 130 a, 130 b of each jaw half 128 a, 128 b of the electric plier head portion 102 shown in FIG. 2 includes a plurality of elongated teeth; and the tool element 131 a, 131 b shown on the interior surface 130 a, 130 b of each jaw half 128 a, 128 b of the electric plier head portion 102 shown in FIG. 3 includes a plurality of elongated concave grooves.

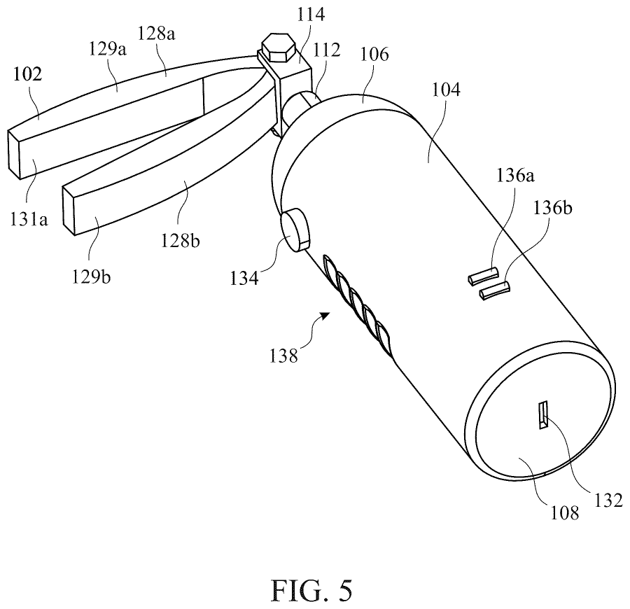

Referring now also to FIGS. 4-5, with reference still to FIGS. 1-3, there is shown a front view of the electric plier for hair extensions 100 (FIG. 4) and a bottom perspective view of the electric plier for hair extensions 100 (FIG. 5).

As above, an object of the electric plier for hair extensions 100 is to provide a more comfortable experience to individuals when installing and removing hair extensions. As such, the electric plier for hair extensions 100 may include comfort elements to aid in usability thereof. Particularly, as shown most clearly in FIG. 4, comfort grips 138 may also be provided on the body 105 of the charging dock portion 104. For example, the comfort grips 138 may include grooves 138 a, 138 b, 138 c, 138 d, 138 e for accepting fingers of a user, enabling the user to firmly and comfortably grasp the body 105 of the charging dock portion 104 in use.

Further, as shown here, a power button 134 may be located on the body 105 of the charging dock portion 104. The power button 134 may be in communication with the pair of jaw halves 128 a, 128 b such that actuation of the power button 134 closes the pair of jaw halves 128 a, 128 b.

In some aspects, one or more settings buttons 136 a, 136 b may further be located on the body 105 of the charging dock portion 104. The one or more settings buttons 136 a, 136 b may be in communication with the power button 134. Selection of one or more settings may control the degree of closure of the pair of jaw halves 128 a, 128 b. For example, one setting button (136 a or 136 b) may enable the pair of jaw halves 128 a, 128 b to completely close upon pressing the power button 134; and another setting button (136 a or 136 b) may cause the pair of jaw halves 128 a, 128 b to close partially upon pressing the power button 134.

In addition, in some aspects, a charging dock portion 104 may include a rechargeable battery (not illustrated) disposed therewithin to provide power to the various elements of the electric plier for hair extensions 100 and enable opening and closing of the pair of jaw halves 128 a, 128 b.

As shown in FIG. 5, located at a side of the body 105 of the charging dock portion 104 may include a charging port 132 in communication with the rechargeable battery and configured to accept a charging cable (not illustrated) to provide power to the rechargeable battery, thereby enabling recharging of the rechargeable battery. For example, the charging port 132 may be located on the charging dock portion bottom end 108 of the charging dock portion 104, as shown here.

Referring now also to FIGS. 6-8, showing various side perspective views of the plurality of electric plier head portions 102, according to one or more aspects of the present disclosure. As shown here and discussed above, each of the plurality of electric plier head portions 102 may include an exterior surface 129 a, 129 b and an interior surface 130 a, 130 b opposite the exterior surface 129 a, 129 b, and in some aspects, at least a portion of the interior surface 130 a, 130 b may include a tool element 131 a, 131 b for achieving a particular purpose in the hair extensions.

As discussed above and shown in FIGS. 1-3, the tool element 131 a, 131 b shown on the interior surface 130 a, 130 b opposite of each jaw half 128 a, 138 b of the electric plier head portion 102 shown in FIG. 6 may include a smooth flat surface; the tool element 131 a, 131 b shown on the interior surface 130 a, 130 b opposite of each jaw half 128 a, 138 b of the electric plier head portion 102 shown in FIG. 7 may include a plurality of elongated teeth; and the tool element 131 a, 131 b shown on the interior surface 130 a, 130 b opposite of each jaw half 128 a, 138 b of the electric plier head portion 102 shown in FIG. 8 may include a plurality of elongated concave grooves.

Further, as above, each of the plurality of electric plier head portions 102 may include a pair of second apertures 125 each attached to a side of each of the plurality of electric plier head portions 102 configured to interface with the charging dock portion fastener assembly 110 of the charging dock portion 104.

In use, a user may select an appropriate electric plier head portion 102 based on the desired result for the hair extension. The user may then attach the selected electric plier head portion 102 to the charging dock portion 104 via the plier head fastener portion and the corresponding fastener on the pair of jaw halves 128 a, 128 b. The user may then use the electric plier for hair extensions 100 to achieve the desired result.

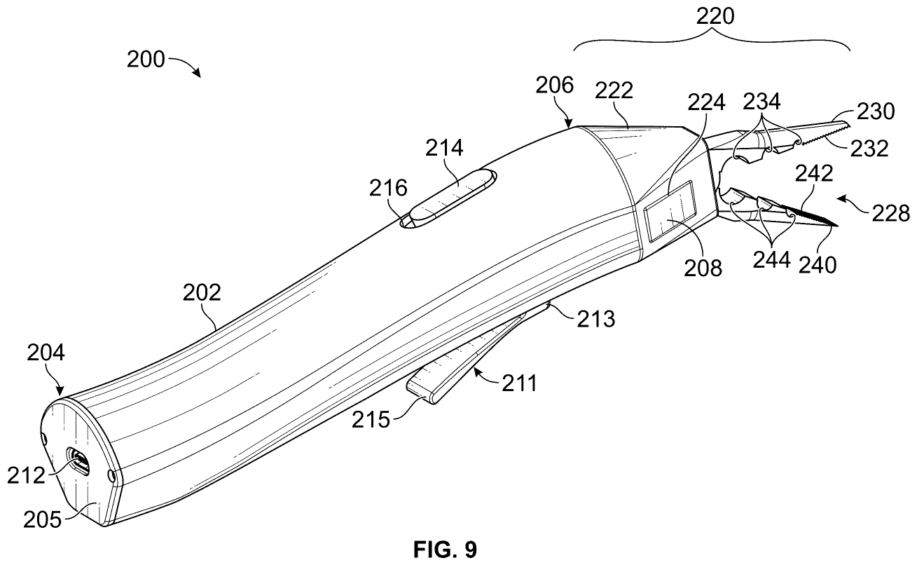

### The Examples of FIGS. 9-14

FIG. 9 shows another example of an electric plier for hair extensions, illustrated herein as an electric crimping tool 200, according to aspects of the present disclosure. For purposes of description herein, the terms “upper”, “lower”, “left”, “rear”, “right”, “front”, “vertical”, “horizontal”, and derivatives thereof shall relate to the disclosure as oriented in FIG. 9. The electric crimping tool 200 may have a body 202 by which a user may grasp the electric crimping tool 200. While the body 202 is illustrated herein as having an elongated shape that is generally cylindrical or tubular, it is understood that such a shape or profile is not limiting, and that the body 202 may have any suitable shape for a user to grasp the handheld electric crimping tool 200 in an ergonomically suitable grip or position.

The body 202 may define a first end 204, which may be thought of as a charging end 204, and a second end 206, opposite the first end 204, wherein the second end 206 may be thought of as an attachment end 206. At least one attachment tab 208 may protrude from the second end 206 of the body 202.

The first end 204 of the body 202 may include an end surface 205 that at least partially defines a charging port 212. The charging port 212 may be configured to receive an electric charging cord (not shown), non-limiting examples of which may include USB chargers of types A, B, or C, mini USB chargers, micro USB chargers, 6-pin or 8-pin chargers, among others. In another example, the charging port 212 may be configured to mount on a charging stand or dock (not shown), such as for inductive or magnetic charging. In such an example, the end surface 205 may be substantially flat to allow the electric crimping tool 200 to stand upright on the charging stand or dock, or the end surface 205 may have any suitable shape or profile so as to be complementary with the shape of the charging stand or dock.

The body 202 may further include at least one mode selector 214 that allows a user to select an operating mode for the electric crimping tool 200. By way of non-limiting example, the mode selector 214 may be used to select between power on and power off modes, or to select between automatic and manual modes of operation, among other options. While the mode selector 214 is illustrated herein as being slidable within a selector channel 216 at least partially defined by the body 202, it is understood that the mode selector 214 could be provided as any suitable type of selector 214, non-limiting examples of which include one or more depressible buttons, a toggling switch, a rocker switch, a rotatable knob, and the like.

Further yet, the body 202 may include an actuator, illustrated herein as a trigger 211 configured to actuate automatic action of the electric crimping tool 200. The trigger 211 may comprise a trigger pivot body 213 that is pivotably coupled to the body 202. A trigger pull 215 may extend from the trigger pivot body 213 exterior from the body 202. The trigger pull 215 may be spaced from or may extend away from the body 202, such that a user may depress the trigger pull 215 toward the body 202 to actuate the trigger 211. It is understood that the trigger 211 could alternately be provided as a different type of actuator, non-limiting examples of which include a button, a knob, or another type of switch.

The electric crimping tool 200 further comprises a crimping head 220, which may be removable and detachable from the body 202, such as to be interchangeable with a variety of crimping heads 220. The crimping head 220 comprises a mounting body 222 configured to be selectively mounted to the body 202. The mounting body 222 may define at least one attachment aperture 224 that is configured to at least partially receive the at least one attachment tab 208 of the body 202 to secure the mounting body 222 to the body 202.

The mounting body 222 carries a pair of movable crimping jaws 228, illustrated herein as a first or upper jaw 230 and a second or lower jaw 240. Each of the upper jaw 230 and the lower jaw 240 may include a toothed surface 232, 242, respectively. The toothed surfaces 232, 242 may be generally flat or linear portions of the upper and lower jaws 230, 240 that define a plurality of teeth or grooves for improved grip, such as against a portion of a hair extension to be crimped for application or for removal. In an alternative embodiment, the upper and lower jaws 230, 240 may be flat or smooth, include grooves, rivets, or teeth, and/or may correspond in shape to a hair extension clip or fastener, or any other surface type.

Further, in alternate examples, the upper and lower jaws 230, 240 may have a variety of other features or options. For example, the upper and lower jaws 230, 240 may have a variety of shapes and configurations, such as those examples discussed with respect to the electric pliers 100. In another example, the upper and lower jaws 230, 240 may have the shape and structure as illustrated, but it is contemplated that various other attachments or surfaces may be attached to the upper and lower jaws 230, 240 to provide different functionalities to the electric crimping tool 200, such as by clip-on or snap attachment to the upper and lower jaws 230, 240. In yet another example, the upper and lower jaws 230, 240 may be extendable or capable of being positioned at multiple angles relative to the mounting body 222.

Each of the upper jaw 230 and the lower jaw 240 may further at least partially define at least one crimping channel 234, 244, respectively. The crimping channels 234 of the upper jaw 230 may be aligned with the crimping channels 244 of the lower jaw 240, such that when the pair of crimping jaws 228 are closed, the crimping channels 234, 244 collectively form openings in the pair of crimping jaws 228 that can be used for crimping hair extensions of varying diameters. As illustrated herein, the crimping channels 234, 244 are provided as a plurality of crimping channels 234, 244 having differing diameters, though it will be understood that any suitable number of crimping channels 234, 244 may be included and may have any suitable diameter, including having the same diameters.

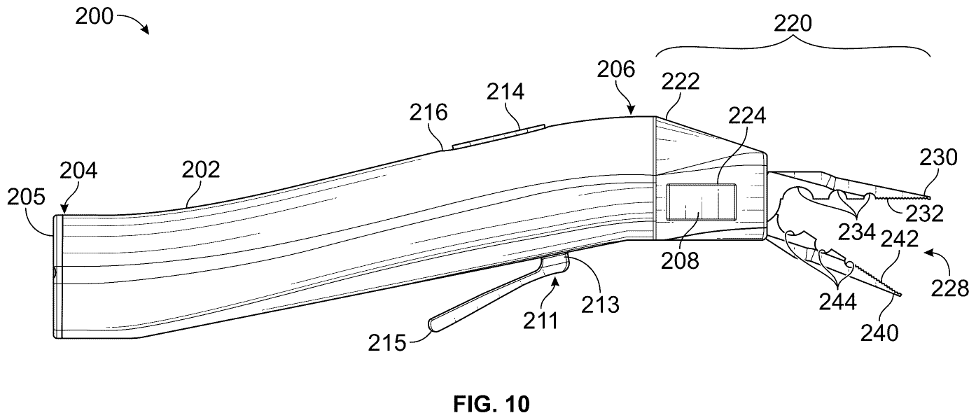

Referring now to FIG. 10, the side view of the electric hair crimper 200 better illustrates the shape and profile of the body 202. In the illustrated example, the body 202 is generally cylindrical and angles upwardly from the first end 204 to the second end 206. It is understood that the degree of incline from the first end 204 to the second end 206 may be any suitable incline and may be chosen for ergonomic optimization for holding by a user. It is also understood that the degree of incline from the first end 204 to the second 206 may be zero, such that the body 202 is generally flat and horizontal between the first and second ends 204, 206.

Further, the body 202 may have any suitable shape or configuration, such that the body 202 and the crimping head 220 may have a generally in-line configuration, as shown, or that the body 202 and the crimping head 220 may form an angled configuration relative to one another, as in the example of the electric plier 100. In another example, it is contemplated that the body 202 may include an extendable portion or feature.

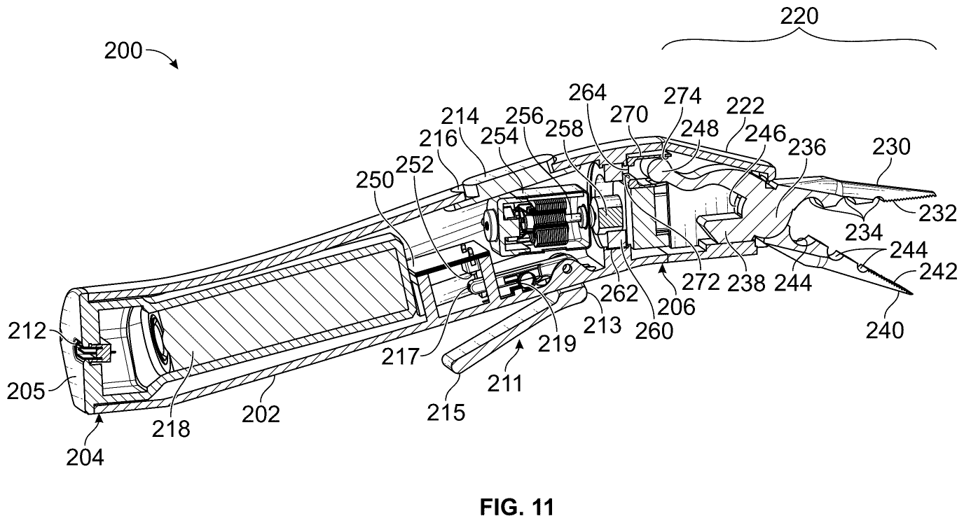

The cross-sectional view of FIG. 11 illustrates the operating mechanisms of the electric crimping tool 200 that are operably coupled with and configured to actuate and effect opening and closing of the pair of movable crimping jaws 228, which may be automatic opening and closing of the pair of movable crimping jaws 228. A power supply, illustrated herein as a battery 218 is carried within the body 202. The battery 218 may be rechargeable and is operably coupled with the charging port 212 for recharging of the battery 218. In one example, the operable coupling of the charging port 212 and the battery 218 may be configured such that the electric crimping tool 200 may be used wirelessly for as long as the battery 218 holds its charge, and the charging port 212 may be coupled to the charging cord to recharge the battery 218 when the electric crimping tool 200 is not in use by a user. In another example, the electric crimping tool 200 may be configured for corded operation, wherein the electric crimping tool 200 may be operated by a user even when the charging cord is connected to the charging port 212, or the charging port 212 can be provided in a permanently corded configuration with an electrical cord being non-removably coupled with the charging port 212 and having a plug for connection with an electrical outlet at its other end.

The battery 218 is further operably coupled, either directly or indirectly, with an electrical control unit (ECU), illustrated herein as a printed circuit board (PCB) 250, for the electric crimping tool 200, as well as with an electric motor 254 that is mounted within the body 202, for selectively providing power to the electric motor 254. At least one depressible switch 252 may be operably and electrically connected with the PCB 250. The PCB 250 is further operably coupled with the electric motor 254. Further, the mode selector 214 may also be operably coupled with the PCB 250 and/or with the electric motor 254.

The pivotable coupling of the trigger pivot body 213 with the body 202 is also shown. While the trigger pull 215 extends from the trigger pivot body 213 exterior of the body 202, the trigger 211 further comprises an actuating arm 217 that extends from the trigger pivot body 213 within the interior of the body 202. A trigger spring 219 is provided within the body 202 and is coupled to both the body 202 and to the actuating arm 217. The trigger spring 219 may be configured to bias the actuating arm 217 toward the body 202 and away from the depressible switch 252 on the PCB 250. Thus, in the non-actuated position of the trigger 211, as shown, the trigger pull 215 is spaced from body 202 and is held in the non-actuated position by the force of the trigger spring 219 pulling the actuating arm 217 against the body 202. With the trigger 211 in this non-actuated position, the actuating arm 217 is not in contact with the depressible switch 252.

The electric motor 254 comprises an output shaft 256 that is configured to rotate when the electric motor 254 is energized. The output shaft 256 extends outwardly beyond the electric motor 254. A first circular gear 258, illustrated herein as an interior circular gear 258, is coupled to the output shaft 256 exterior to the electric motor 254 and is configured for coaxial rotational movement along with the output shaft 256 when the electric motor 254 is energized. A second circular gear 260, illustrated herein as an exterior circular gear 260, is provided about the interior circular gear 258 and in contact with the interior circular gear 258 such that rotation of the interior circular gear 258 in turn drives rotation of the exterior circular gear 260.

The exterior circular gear 260 has a diameter that is greater than a diameter of the interior circular gear 258. Thus, while the exterior circular gear 260 is positioned about the circumference of the interior circular gear 258, the relative size difference between the interior and exterior circular gears 258, 260 results in a non-concentric alignment of the interior and exterior circular gears 258, 260. Rather, the interior and exterior circular gears 258, 260 are arranged in an eccentric configuration, with parallel, but not coaxial, axes of rotation. Thus, the interior and exterior circular gears 258, 260 may be thought of collectively as a set of eccentric gears.

The exterior circular gear 260 is retained within a circular channel 262 defined by the body 202. The retention of the exterior circular gear 260 within the circular channel 262 allows for rotational movement of the exterior circular gear 260 within the circular channel 262, but prevents lateral movement of the exterior circular gear 260, ensuring that the exterior circular gear 260 maintains alignment and contact with the interior circular gear 258.

The exterior circular gear 260 further includes a peg 264 that protrudes laterally outwardly from the exterior circular gear 260, away from the electric motor 254. The peg 264 engages with a linear gear 270 to operably couple the exterior circular gear 260 with the linear gear 270. The linear gear 270 defines a lateral channel 272 within which the peg 264 is at least partially received. The linear gear 270 further defines a receiving aperture 274 opposite the lateral channel 272. The receiving aperture 274 may be positioned at or near the second end 206 of the body 202.

The lateral channel 272 may have a width that is equal to or greater than the diameter of the exterior circular gear 260, such that the peg 264 can move from side-to-side within the lateral channel 272 as the exterior circular gear 260 rotates. In this way, the rotational movement of the exterior circular gear 260 drives linear movement of the linear gear 270 along an axis that is generally transverse to the axis of movement of the peg 264 within the lateral channel 272. In the example illustrated in FIG. 11, the illustrated orientation of the electric crimping tool 200 results in an orientation of the lateral channel 272 that allows generally side-to-side movement of the peg 264 within the lateral channel 272, while driving generally up-and-down movement of the linear gear 270.

The cross-sectional view of FIG. 11 further illustrates the attachment and arrangement of the pair of movable crimping jaws 228 within the crimping head 220. The upper jaw 230 further comprises an upper jaw body 236 from which the upper jaw 230 extends. A mounting end 238 may also extend from the upper jaw body 236, such as generally from an opposite side of the upper jaw body 236 than the upper jaw 230 extends from. The mounting end 238 may be attached to the mounting body 222 such that the mounting end 238 couples the pair of movable crimping jaws 228 to the crimping head 220.

Similarly, the lower jaw 240 may also comprise a lower jaw body 246 from which the lower jaw 240 extends. While the upper jaw body 236 fixes the upper jaw 230 to the mounting body 222 in a stationary manner, the lower jaw body 246 may be pivotably or rotatably coupled to the upper jaw body 236, such that the lower jaw body 246 defines an axis of rotation or pivot axis for the lower jaw 240. A free end 248 may also extend from the lower jaw body 246, such as generally from an opposite side of the lower jaw body 246 than the lower jaw 240 extends from. The free end 248 may be at least partially received within the receiving aperture 274 of the linear gear 270 when the crimping head 220 is attached to the body 202, such that linear movement of the linear gear 270 in turn drives linear movement of the free end 248, which rotates or pivots the lower jaw 240 about the lower jaw body 246 to open and close the pair of movable crimping jaws 228.

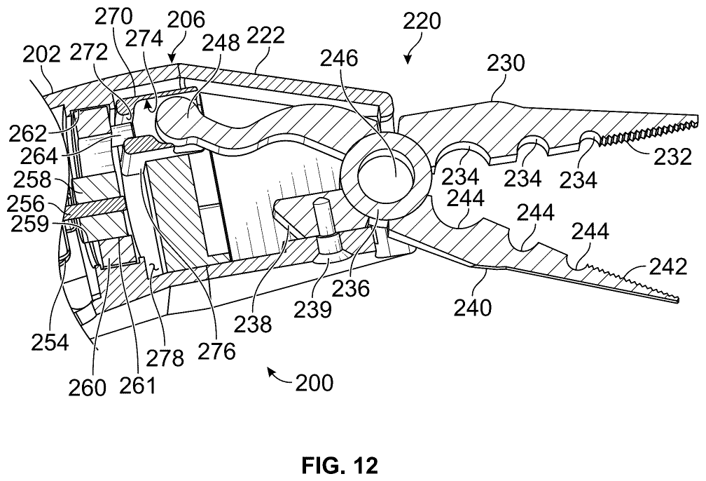

The enlarged cross-sectional view of FIG. 12 better illustrates the contact between the interior circular gear 258 and the exterior circular gear 260. Specifically, an outer surface 259 of the interior circular gear 258 engages with an inner surface 261 of the exterior circular gear 260, such as in a frictional engagement. In one example, the outer surface 259 of the interior circular gear 258 and the inner surface 261 of the exterior circular gear 260 may be provided as toothed or grooves surfaces that are complementary with one another to allow rotation of the interior circular gear 258 to drive rotation of the exterior circular gear 260 via enmeshment of the toothed outer surface 259 and inner surface 261. It is also contemplated that the outer surface 259 and the inner surface 261 may not be toothed, but rather the interior circular gear 258 and the exterior circular gear 260 may be fitted together tightly enough for frictional engagement of the outer surface 259 of the interior circular gear 258 with the inner surface 261 of the exterior circular gear 260 to drive rotation of the exterior circular gear 260.

The linear gear 270 may further comprise at least one retaining flange 276 that is at least partially received within a linear channel 278 defined by the body 202. This arrangement allows for the generally up-and-down linear movement of the linear gear 270 within the linear channel 278, while preventing side-to-side or longitudinal movement of the linear gear 270 that may otherwise allow disengagement of the peg 264 from the lateral channel 272 or of the free end 248 from the receiving aperture 274. In one example, the body 202 may define two linear channels 278 on opposing sides of the body 202, with the linear gear 270 extending the width between the two linear channels 278 and defining retaining flanges 276 on opposing ends of the linear gear 270, such that the movement of the linear gear 270 is constrained within the linear channels 278 at both sides of the linear gear 270.

The attachment of the mounting end 238 of the upper jaw 230 to the mounting body 222 may be accomplished by a mechanical fastener 239. Non-limiting examples of such a mechanical fastener 239 include a screw, a bolt, heat staking, overmolding or co-molding, the use of an adhesive, or any other suitable fastening means.

Turning now to the operation of the electric crimping tool 200, when the battery 218 has a sufficient charge and a user operates the electric crimping tool 200, the mode selector 214 may be positioned to select a power on mode, which results in operable communication to the PCB 250 to cause energization of the depressible switch 252. With the depressible switch 252 being energized, pressure or pulling applied by a user to the trigger pull 215 that overcomes the force of the trigger spring 219 causes the trigger 211 to pivot or rotate about the trigger pivot body 213, moving from the non-actuated position and moving the actuating arm 217 away from the body 202 and into the actuated position, where the actuating arm 217 is in contact with the depressible switch 252 to actuate the depressible switch 252.

In such an example where the electric crimping tool 200 includes the mode selector 214, it is contemplated that, when the mode selector 214 is positioned to select a power off mode, the depressible switch 252 is not energized, and thus depression of the trigger 211 does not actuate operation of the electric crimping tool 200 even when the actuating arm 217 contacts the depressible switch 252. Alternately, in an example where the electric crimping tool 200 does not include the mode selector 214, it is contemplated that the depressible switch 252 would always be energized and depression of the trigger 211 to actuate the depressible switch 252 would be sufficient to actuate operation of the electric crimping tool 200.

Regardless of whether the mode selector 214 is included, when the depressible switch 252 is energized and is actuated by the actuating arm 217 of the trigger 211, the PCB 250 initiates actuation of the electric motor 254 to operate. The operation of the electric motor 254 results in rotation of the output shaft 256, which in turn rotates the interior circular gear 258 that is carried by the output shaft 256. The rotation of the interior circular gear 258 then rotates the exterior circular gear 260 due to frictional engagement. As the exterior circular gear 260 rotates within the circular channel 262, the peg 264 moves laterally within the lateral channel 272 of the linear gear 270. The rotational movement of the peg 264 between the top and the bottom of the circular channel 262 bears against the lateral channel 272 to drive linear movement of the linear gear 270 in a direction generally transverse to the lateral channel 272.

When the crimping head 220 is attached to the body 202 with the free end 248 of the lower jaw 240 positioned within the receiving aperture 274 of the linear gear 270, the linear movement of the linear gear 270 in the generally up-and-down direction in turn effects the same movement of the free end 248 of the lower jaw 240, rotating the lower jaw 240 about the lower jaw body 246 and causing opening and closing of the pair of movable crimping jaws 228 as the linear gear 270 moves up and down. In this way, the electric crimping tool 200 allows not only for automatic closing of the pair of movable crimping jaws 228, but also for the automatic opening of the pair of movable crimping jaws 228, reducing strain and stress on a user when operating the electric crimping tool 200.

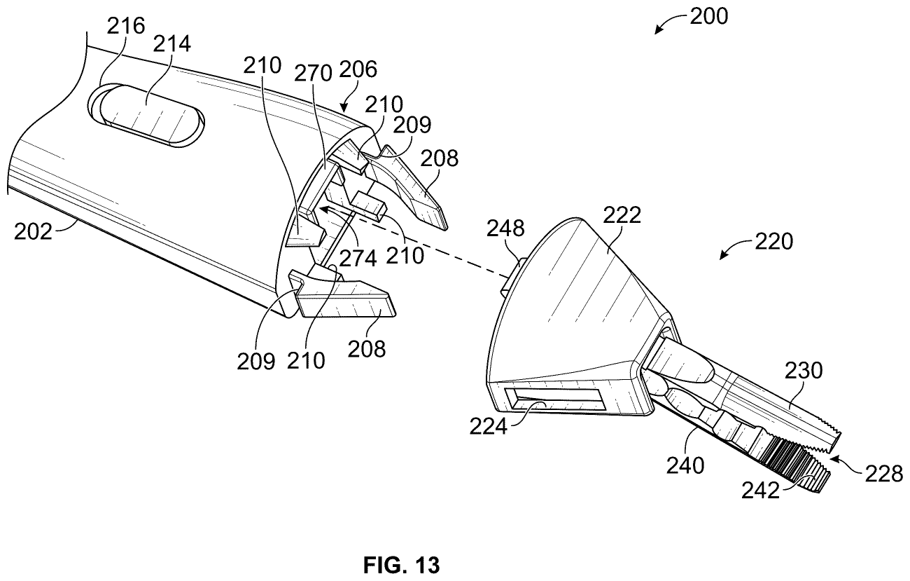

The partially exploded view of FIG. 13 illustrates the structure of and attachment mechanisms between the body 202 and the crimping head 220 of the electric crimping tool 200. In the illustrated example, the body 202 includes two attachment tabs 208 protruding from the second end 206 of the body 202. While the two attachment tabs 208 are shown as being positioned opposite one another about the body 202, it is understood that any suitable number and position of attachment tabs 208 may be included with the body 202. Each of the attachment tabs 208 defines an attachment surface 209 configured to be at least partially received within the respective attachment aperture 224 on the mounting body 222 of the crimping head 220. When the attachment tabs 208 are received within the attachment apertures 224, the attachment surfaces 209 may bear against and/or be retained by the attachment apertures 224 to securely couple the crimping head 220 to the body 202. In order to remove the crimping head 220 from the body 202, a user may depress the attachment tabs 208 to allow removal of the mounting body 222 from the body 202.

The body 202 may further define at least one alignment lug 210, illustrated herein as a plurality of alignment lugs 210. The alignment lugs 210 protrude from the second end 206 of the body 202 in a similar fashion to the attachment tabs 208. The alignment lugs 210 may be compatible or complementary with internal structures of the mounting body 222 of the crimping head 220 to ensure proper alignment of the body 202 and the crimping head 220 when a user attaches the crimping head 220 to the body 202. When more than one alignment lug 210 is included, the alignment lugs 210 may all have the same shape and size, or the shape and size of the alignment lugs 210 may differ from one another.

When a user attaches the crimping head 220 to the body 202, proper attachment is ensured by aligning the free end 248 of the lower jaw 240 with the linear gear 270, such that the free end 248 is received within the receiving aperture 274, as well as by aligning the attachment tabs 208 within the attachment apertures 224 and the alignment lugs 210 with the mounting body 222.

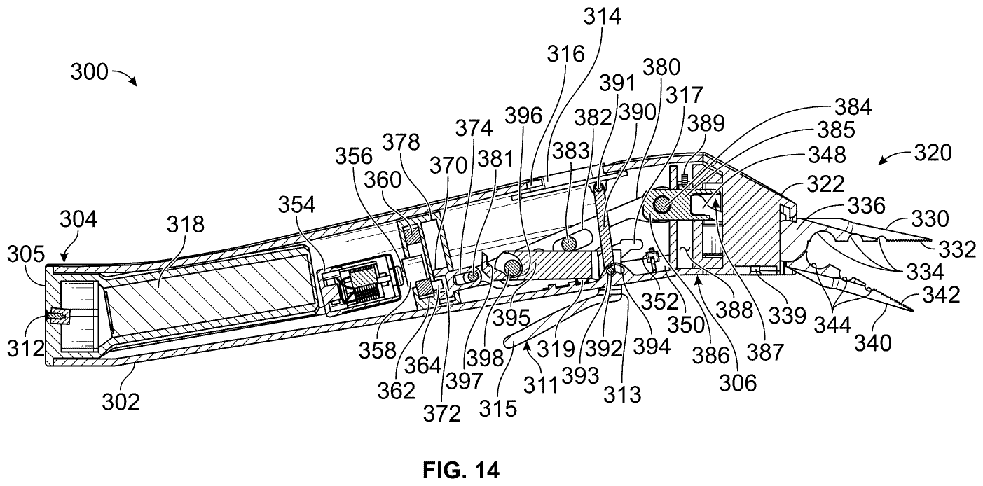

Referring now to FIG. 14, a side cross-sectional view of another example of an electric crimping tool 300 is shown. The electric crimping tool 300 shares many similarities with the electric crimping tool 200; therefore, like parts of the electric crimping tool 300 are labeled with like numerals to the electric crimping tool 200, with reference numerals increased by 100. It is understood that the description of like parts from the electric crimping tool 200 apply also to the like parts of the electric crimping tool 300.

The external structure of the electric crimping tool 300 may be the same as that of the electric crimping tool 200, with a body 302 having a first end 304 or charging end 304, and a second end 306 or attachment end 306, an end surface 305 with a charging port 312, a mode selector 314 slidable within a selector channel 316, and a trigger 311 with a trigger pull 315 extending from a trigger pivot body 313.

The crimping head 320 may also be the same as the crimping head 220, including the parts of the crimping head 320 not seen in the view of FIG. 14. Referring to the portions of the crimping head 320 that are illustrated in the view of FIG. 14, the crimping head 320 includes a mounting body 322 carrying a pair of movable crimping jaws, illustrated herein as a first or upper jaw 330 and a second or lower jaw 340, each including a toothed surface 332, 342, respectively, and at least one crimping channel 334, 344, respectively. Further, the upper jaw 330 comprises an upper jaw body 336 and a mounting end (not shown) attached to the mounting body 322 by a fastener 339, while the lower jaw 340 comprises a lower jaw body (not shown) and a free end 348.

The electric crimping tool 300 differs from the electric crimping tool 200 mainly in the operating mechanisms of the electric crimping tool 300 that are housed within the body 302. Similarly to the electric crimping tool 200, the electric crimping tool 300 includes a battery 318 operably coupled with the charging port 312, with a PCB 350 in turn operably and electrically coupled with a depressible switch 352, and with an electric motor 354. The PCB 350 is also operably coupled with the electric motor 354, with the mode selector 314 also operably coupled with the PCB 350 and with the electric motor 354.

The features of the trigger 311 are also similar to those of the trigger 211 with an actuating arm 317 extending from the trigger pivot body 313 within the interior of the body 302, and a trigger spring 319 provided within the body 302 and coupling the body 302 to the actuating arm 317 to bias the actuating arm 317 away from the depressible switch 352. However, the trigger 311 differs from the trigger 211 in that the actuating arm 317 extends from the trigger pivot body 313 in the opposite direction than the trigger pull 315 extends from the trigger pivot body 313, such that the depressible switch 352 is positioned between the trigger pivot body 313 and the attachment end 306 of the body 302, which differs from the position of the depressible switch 252 between the trigger pivot body 213 and the charging end 204 of the body 202.

Further similarly to the electric crimping tool 200, the electric motor 354 comprises a rotatable output shaft 356 extending from the electric motor 354 and coupled to a first circular gear 358 or interior circular gear 358. The interior circular gear 358 is operably coupled with a second circular gear 360 or exterior circular gear 360 to drive rotation of the exterior circular gear 360 within a circular channel 362 defined by the body 302. The exterior circular gear 360 includes a peg 364 that engages with a motor linear gear 370. The motor linear gear 370 is similar to the linear gear 370 in that the motor linear gear 370 defines a lateral channel 372 within which the peg 364 is at least partially received and a receiving channel 374 opposite the lateral channel 372, and in that the motor linear gear 370 is configured for linear movement in a direction generally transverse to the lateral channel 372 and within a motor linear channel 378.

However, unlike the receiving aperture 274 of the linear gear 270 that is positioned at or near the second end 206 of the body 202, the receiving channel 374 of the motor linear gear 370 is positioned within the body 302, but not at the attachment end 306, and the receiving channel 374, rather than receiving the free end 348 of the lower jaw 340, instead receives a linkage pin 381 of a working linkage 380 that operably couples the motor linear gear 370 with the crimping head 320.

The working linkage 380 defines a mounting opening 382 that mounts the working linkage 380 to a mounting pin 383 that extends from the body 302. The mounting pin 383 extends through the mounting opening 382 of the working linkage 380 to fix the working linkage 380 within the body 302 and is further configured to allow pivotable and limited slidable movement of the working linkage 380 about the mounting pin 383. In this way, the mounting pin 383 defines a pivot axis for the working linkage 380. The mounting opening 382 may be formed in the working linkage 380 generally near a midpoint of the working linkage 380. With the working linkage 380 coupled to the mounting pin 383 near its midpoint and coupled to the motor linear gear 370 by the linkage pin 381 at one end of the working linkage 380, the opposite end of the working linkage 380 from the linkage pin 381 is coupled to a working linkage fastener 384.

The working linkage fastener 384 couples the working linkage 380 with a main linear gear 385. The main linear gear 385 operates similarly to the linear gear 270 and to the motor linear gear 370. The main linear gear 385 comprises a first end 386, illustrated herein as a fastener end 386, that is operably coupled to the working linkage 380 by the working linkage fastener 384, and a second end defining a receiving aperture 387 opposite the fastener end 386. The receiving aperture 387 may be positioned at or near the attachment end 306 of the body 302. The main linear gear 385 further comprises at least a portion that is received within a main linear channel 388 defined by the body 302 and configured to guide linear movement of the main linear gear 385 in the same manner as the movement of the linear gear 270 within the linear channel 278. A linear gear spring 389 couples the main linear gear 385 to the body 302 and is configured to bias the main linear gear 385 toward an uppermost position within the main linear channel 388.

Similar to the free end 248 of the lower jaw 240 being received within the receiving aperture 274 of the linear gear 270, the receiving aperture 387 of the main linear gear 385 may receive the free end 348 of the lower jaw 340 in order to operably couple the crimping head 320 with the main linear gear 385, the working linkage 380, the motor linear gear 370, and so on. In this way, the rotatable movement of the output shaft 356, the interior circular gear 358, and the exterior circular gear 360 and its peg 364 drive linear movement of the motor linear gear 370. The linear movement of the motor linear gear 370 in turn drives pivotable movement of the working linkage 380 in such a way that downward movement of the motor linear gear 370 pulls the coupled linkage pin 381 of the working linkage 380 similarly downward, resulting in the working linkage 380 pivoting about the mounting pin 383, and in turn driving upward movement of the working linkage fastener 384. Upward movement of the working linkage fastener 384 also pulls the main linear gear 385 upward, and thus also the free end 348 of the lower jaw 340, which opens the lower jaw 340 relative to the upper jaw 330.

The mode selector 314 of the electric crimping tool 300 may be used to select between automatic and manual modes of operation. In the illustrated example, the position of the mode selector 314 may be slid toward the attachment end 306 of the body 302, which may be associated with the manual mode of operation. Actuation of the selectable modes of operation by the mode selector 314 is driven by a switch linkage 390 having a first end 391 that is coupled to the mode selector 314 and a second end 392 that is coupled to the body 302 and the trigger 311. The second end 392 may be fixed to the trigger pivot body 313, but slidably coupled to the body 302, such that the second end 392 can rest either in a first slot end 393 or a second slot end 394. In the manual mode as illustrated, the second end 392 of the switch linkage 390 rests in the first slot end 393, which is further from the attachment end 306 and further from the depressible switch 352 than the second slot end 394. Thus, with the second end 392 in the first slot end 393, the actuating arm 317 of the trigger 311 is unable to contact the depressible switch 352.

The electric crimping tool 300 further includes a trigger linkage 395 that is operably coupled with the trigger 311 and with the switch linkage 390 to implement and actuate the selectable modes of operation. The trigger linkage 395 extends away from the trigger pivot body 313 and away from the depressible switch 352 and terminates toward the linkage pin 381 of the working linkage 380. The trigger linkage 395 defines a first slot end 396 and a second slot end 397 configured to alternately receive a trigger linkage fastener 398. The trigger linkage fastener 398 couples the trigger linkage 395 with the working linkage 380. As shown, when the second end 392 of the switch linkage 390 rests in the first slot end 393, the trigger linkage fastener 398 rests in the first slot end 396 of the trigger linkage 395.

When the mode selector 314 is used to select the automatic or electric mode of operation, the mode selector 314 is slid to the position toward the charging end 304 of the body 302, and slightly away from the attachment end 306 relative to the position of the mode selector 314 in the manual mode of operation. This change in position of the mode selector 314 actuates movement of the switch linkage 390, such that the second end 392 of the switch linkage 390 moves from the first slot end 393 into the second slot end 394. This movement of the second end 392 of the switch linkage 390 into the second slot end 394 pulls the whole trigger 311 slightly toward the attachment end 306 of the body 302 and the depressible switch 352. Thus, with the second end 392 in the second slot end 394, the actuating arm 317 of the trigger 311 overlies and is positioned to be able to contact the depressible switch 352 when the trigger pull 315 is depressed. The trigger linkage 395 is also pulled slightly toward the attachment end 306 of the body 302, along with the trigger 311, such that the trigger linkage fastener 398 moves from the first slot end 396 to the second slot end 397 of the trigger linkage 395.

Turning now to the operation of the electric crimping tool 300, when the mode selector 314 is in the position associated with the manual mode of operation, the second end 392 of the switch linkage 390 rests in the first slot end 393, such that the actuating arm 317 of the trigger 311 is unable to contact the depressible switch 352, and the trigger linkage fastener 398 rests in the first slot end 396 of the trigger linkage 395. Since the position of the trigger 311 is such that the actuating arm 317 is not able to actuate the depressible switch 352, the electric motor 354 is not energized and remains in what can be thought of as a non-energized coasting mode, wherein the output shaft 356 is not driven to rotate, but is also not prevented from rotating.

In this manual mode of operation, pressure or pulling applied by a user to the trigger pull 315 that overcomes the force of the trigger spring 319 causes the trigger 311 to pivot or rotate about the trigger pivot body 313, which in turn causes the trigger linkage 395 to similarly rotate or pivot away from the body 302. As the trigger linkage 395 is pivoted upwardly and away from the body 302, the first slot end 396 of the trigger linkage 395 bears against the trigger linkage fastener 398, the generally upward pressure driving the linkage pin 381 end of the working linkage 380 to likewise be raised. As the linkage pin 381 end of the working linkage 380 is moved generally upwardly, the working linkage 380 pivots about the mounting pin 383, causing the working linkage fastener 384 end of the working linkage 380 to in turn lower. As the working linkage fastener 384 end of the working linkage 380 lowers, the main linear gear 385 is lowered along with it, which in turn lowers the free end 348 of the lower jaw 340 along with the main linear gear 385. As the free end 348 is lowered, the lower jaw 340 is brought up to meet the upper jaw 330 and perform crimping action.

When the user releases the pressure on the trigger pull 315, the trigger spring 319 biases the trigger 311 to return to the non-actuated position, moving the trigger pull 315 outwardly away from the body 302, while the linear gear spring 389 pulls the main linear gear 385 upwardly and toward the linear gear spring 389, returning the lower jaw 340 to the opened, non-crimping position. Thus, even in the manual mode of operation, the upper and lower jaws 330, 340 of the crimping head 320 are returned automatically to the opened, non-crimping position, eliminating the need for a user to make additional hand movement to open the electric crimping tool 300 once crimping is completed.

Referring now to the operation of the electric crimping tool 300 in the automatic or electric mode of operation, when the mode selector 314 is in the position associated with the electric mode of operation, the second end 392 of the switch linkage 390 rests in the second slot end 394, such that the trigger 311 is shifted toward the attachment end 306 of the body 302 and the actuating arm 317 overlies and is able to contact the depressible switch 352, and the trigger linkage fastener 398 rests in the second slot end 397 of the trigger linkage 395.

In this electric mode of operation, when the battery 318 has a sufficient charge, pressure or pulling applied by a user to the trigger pull 315 that overcomes the force of the trigger spring 319 causes the trigger 311 to pivot or rotate about the trigger pivot body 313, moving the actuating arm 317 downwardly toward the body 302 and into contact with the depressible switch 352 to actuate the depressible switch 352. When the depressible switch 352 is actuated by the actuating arm 317 of the trigger 311, the PCB 350 initiates actuation of the electric motor 354 to operate.

The operation of the electric motor 354 results in rotation of the output shaft 356, which in turn rotates the interior circular gear 358 that is carried by the output shaft 356. The rotation of the interior circular gear 358 then rotates the exterior circular gear 360 due to frictional engagement. As the exterior circular gear 360 rotates within the circular channel 362, the peg 364 moves laterally within the lateral channel 372 of the motor linear gear 370. The rotational movement of the peg 364 between the top and the bottom of the circular channel 362 bears against the lateral channel 372 to drive linear movement of the motor linear gear 370 in a direction generally transverse to the lateral channel 372.

For example, as the exterior circular gear 360 rotates and the peg 364 moves from the bottom toward the top of the circular channel 362, the peg 364 bears against the lateral channel 372 to drive generally upward movement of the motor linear gear 370 within the motor linear channel 378. The upward movement of the motor linear gear 370 causes the receiving channel 374 to pull upwardly against the linkage pin 381, driving the linkage pin 381 end of the working linkage 380 to likewise be raised. As the linkage pin 381 end of the working linkage 380 is moved generally upwardly, the working linkage 380 pivots about the mounting pin 383, causing the working linkage fastener 384 end of the working linkage 380 to in turn lower. As the working linkage fastener 384 end of the working linkage 380 lowers, the main linear gear 385 is lowered along with it, which in turn lowers the free end 348 of the lower jaw 340 along with the main linear gear 385. As the free end 348 is lowered, the lower jaw 340 is brought up to meet the upper jaw 330 and perform crimping action.

For as long as the user keeps the trigger pull 315 depressed against the body 302 and actuating the depressible switch 352, the electric operation of the electric crimping tool 300 will continue, opening and closing the upper and lower jaws 330, 340 for repeated crimping action and release.

When the user releases the pressure on the trigger pull 315, the trigger spring 319 biases the trigger 311 to return to the non-actuated position, moving the trigger pull 315 outwardly away from the body 302, while the linear gear spring 389 pulls the main linear gear 385 upwardly and toward the linear gear spring 389, returning the lower jaw 340 to the opened, non-crimping position. Thus, when the user releases the trigger 311, the upper and lower jaws 330, 340 of the crimping head 320 are returned automatically to the opened, non-crimping position, eliminating the need for a user to make additional hand movement to open the electric crimping tool 300 once crimping is completed.

### CONCLUSION

While the examples described in the present disclosure are discussed in their illustrated form, it will be understood that it is within the scope of the present disclosure that various features of the electric pliers 100 and of either of the electric crimping tools 200, 300 may be used interchangeably with one another. For example, features described with respect to the electric pliers 100 may be used with the electric crimping tools 200, 300, and vice versa.

In addition, it is understood that, while the present disclosure described the handheld electric tool as electric pliers or electric crimping tools, such descriptions are not limiting. Rather, the principles of the present disclosure have applicability for many purposes of such a handheld electric tool having an operating mechanism that actuates an automatic movement of a portion of a tool head. By way of non-limiting examples, the principles of the present disclosure may be applied similarly to handheld electric tools used in handheld handiwork or manufacturing, in dental applications, in medical applications, etc. The present disclosure applies generally to a handheld electric tool with an automatic operating mechanism, wherein the shape and function of the components of the tool head may determine applicability and intended use for the electric tool.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for an electric crimping tool, as described above.
Clause 1: An electric crimping tool comprising: a body including a charging port and an actuator; an electric motor; a crimping head mounted to the body, the crimping head including: a mounting body, and a pair of crimping jaws carried by the mounting body, and an operating mechanism operably coupled with the actuator and the electric motor to actuate automatic opening and closing of the pair of crimping jaws.
Clause 2: The electric crimping tool of clause 1, wherein the crimping head is removably mounted to the body.
Clause 3: The electric crimping tool of clause 2, wherein the removably mounted crimping head is interchangeable with other removable crimping heads.
Clause 4: The electric crimping tool of any of clauses 1 through 3, wherein the charging port is configured to couple with an electric charging cord.
Clause 5: The electric crimping tool of any of clauses 1 through 4, wherein the charging port is configured to mount on a charging stand or charging dock.
Clause 6: The electric crimping tool of any of clauses 1 through 5, wherein the electric crimping tool further includes a rechargeable battery operably coupled with the charging port.
Clause 7: The electric crimping tool of any of clauses 1 through 6, wherein the actuator comprises a trigger movable between a non-actuated position and an actuated position.
Clause 8: The electric crimping tool of clause 7, wherein the trigger is biased toward the non-actuated position.
Clause 9: The electric crimping tool of clause 7 or clause 8, further comprising a mode selector for selecting at least an automatic electrical mode of operation of the electric crimping tool.
Clause 10: The electric crimping tool of clause 9, wherein the operating mechanism further includes a trigger linkage operably coupled to the mode selector for selectively engaging the trigger with the electric motor.
Clause 11: The electric crimping tool of any of clauses 1 through 10, wherein the actuator effects energization of the electric motor.
Clause 12: The electric crimping tool of any of clauses 1 through 11, wherein the electric motor has a rotatable output shaft.
Clause 13: The electric crimping tool of clause 12, wherein the output shaft is coupled to a set of eccentric gears.
Clause 14: The electric crimping tool of clause 13, wherein the set of eccentric gears are operably coupled to at least one linear gear to convert rotational motion of the set of eccentric gears to linear motion of the at least one linear gear.
Clause 15: The electric crimping tool of clause 14, wherein the at least one linear gear is coupled to one of crimping jaws to move the pair of crimping jaws between closed and opened positions.
Clause 16: The electric crimping tool of clause 15, wherein the at least one linear gear comprises two linear gears.
Clause 17: The electric crimping tool of clause 16, wherein the operating mechanism further includes a working linkage provided pivotably between and operably coupling the two linear gears.
Clause 18: The electric crimping tool of clause 17, wherein at least one of the linear gears is biased to move the one of the crimping jaws toward the opened position.
Clause 19: An electric plier comprising: a charging dock portion including a charging port and a power button; an electric plier head portion attached to the charging dock portion, the electric plier head portion including a pair of hinged jaw halves; and an automatic means of opening and closing the pair of hinged jaw halves.
Clause 20: The electric plier of clause 19, wherein the electric plier head portion is removably attached to the charging dock portion and is interchangeable with other electric plier head portions.

1. An electric crimping tool comprising:
a body including a charging port and an actuator;
an electric motor;
a crimping head mounted to the body, the crimping head including:
a mounting body, and
a pair of crimping jaws carried by the mounting body, and
an operating mechanism operably coupled with the actuator and the electric motor to actuate automatic opening and closing of the pair of crimping jaws.

2. The electric crimping tool of claim 1 wherein the crimping head is removably mounted to the body.

3. The electric crimping tool of claim 2 wherein the removably mounted crimping head is interchangeable with other removable crimping heads.

4. The electric crimping tool of claim 1 wherein the charging port is configured to couple with an electric charging cord.

5. The electric crimping tool of claim 1 wherein the charging port is configured to mount on a charging stand or charging dock.

6. The electric crimping tool of claim 1 wherein the electric crimping tool further includes a rechargeable battery operably coupled with the charging port.

7. The electric crimping tool of claim 1 wherein the actuator comprises a trigger movable between a non-actuated position and an actuated position.

8. The electric crimping tool of claim 7 wherein the trigger is biased toward the non-actuated position.

9. The electric crimping tool of claim 7, further comprising a mode selector for selecting at least an automatic electrical mode of operation of the electric crimping tool.

10. The electric crimping tool of claim 9 wherein the operating mechanism further includes a trigger linkage operably coupled to the mode selector for selectively engaging the trigger with the electric motor.

11. The electric crimping tool of claim 1 wherein the actuator effects energization of the electric motor.

12. The electric crimping tool of claim 11 wherein the electric motor has a rotatable output shaft.

13. The electric crimping tool of claim 12 wherein the output shaft is coupled to a set of eccentric gears.

14. The electric crimping tool of claim 13 wherein the set of eccentric gears are operably coupled to at least one linear gear to convert rotational motion of the set of eccentric gears to linear motion of the at least one linear gear.

15. The electric crimping tool of claim 14 wherein the at least one linear gear is coupled to one of crimping jaws to move the pair of crimping jaws between closed and opened positions.

16. The electric crimping tool of claim 15 wherein the at least one linear gear comprises two linear gears.

17. The electric crimping tool of claim 16 wherein the operating mechanism further includes a working linkage provided pivotably between and operably coupling the two linear gears.

18. The electric crimping tool of claim 17 wherein at least one of the linear gears is biased to move the one of the crimping jaws toward the opened position.

19. An electric plier comprising:
a charging dock portion including a charging port and a power button;
an electric plier head portion attached to the charging dock portion, the electric plier head portion including a pair of hinged jaw halves; and
an automatic means of opening and closing the pair of hinged jaw halves.

20. The electric plier of claim 19 wherein the electric plier head portion is removably attached to the charging dock portion and is interchangeable with other electric plier head portions.
